(19) United States
(12) Patent Application Publication
(10) Pub. No.: US 2011/0161138 A1
(43) Pub. Date: Jun. 30, 2011

(54) System and Method for Analyzing Performance Data in a Transit Organization

(75) Inventors: Ian Terence KEAVENY, Burlington (CA); Andrew Henry Leitch KERR, Stenhousemuir (GB)

(73) Assignee: TRAPEZE SOFTWARE INC., Mississauga (CA)

(21) Appl. No.: 12/975,735

(22) Filed: Dec. 22, 2010

Related U.S. Application Data
(60) Provisional application No. 61/291,400, filed on Dec. 31, 2009.

(51) Int. Cl. G06Q 10/00

(52) U.S. Cl. 705/7.38; 705/7.11

(57) ABSTRACT

The present invention relates to a system and method for analyzing performance data in a transit organization. Performance data is stored for each of a plurality of runs. The performance data includes at least one factor, parameters and at least one metric for each of the runs. The performance data for a subset of the runs having common parameters and a common variation in at least one of the factors is selected for analysis. The at least one metric for the subset is compared to the at least one metric for other of the runs having the common parameters to determine a relative performance level for the variation.

This application claims priority from U.S. Provisional Patent Application Ser. No. 61/291,400 filed on Dec. 31, 2009, the contents of which are incorporated herein by reference.

### FIELD OF THE INVENTION

The present invention relates to the field of vehicle system monitoring. In particular, it relates to a system and method for analyzing performance data in a transit organization.

### BACKGROUND OF THE INVENTION

Transit organizations have been challenged to serve ever-increasing population centers on restricted budgets. Over the past several years, the cost of fuel has risen almost 50%. As a consequence, fuel now represents a substantial portion of the annual operating budget for transit organizations.

Fuel reductions of only a few percent can, in larger transit organizations, result in savings of millions of dollars. In a recent article, the U.S. Environmental Protection Agency asserted that:
Fleet managers have estimated that driver training and incentive programs typically results in 15% fuel savings. Two trucking fleets in Canada documented the impact of driver training and found fuel efficiency improvements of 18% and 20%, while a Canadian study estimates that many fleets could achieve a 10% fuel economy improvement through driver training and monitoring. A study of the European Commission estimates that an annual one-day driver-training course will improve truck fuel efficiency by 5%.

Fuel economy is just one of a number of metrics that can be measured to provide an indication of driver and/or vehicle performance. Other metrics can include, for example, the “jerkiness” of the ride, hard acceleration and braking, and speeding.

It can be desirable to identify, on an ongoing basis, specific drivers who would most benefit from targeted driver training in order to keep training costs low and reduce interruption of the daily operation of the transit organization. The process of identifying drivers that would best benefit from driver training, however, can prove very difficult. Direct attribution of the poor fuel economy of a vehicle to the driver operating the vehicle can result in a number of drivers being incorrectly flagged as being good candidates for driver training. There are, in fact, a number of parameters that impact the fuel economy of transit vehicles, such as the type of vehicle, the route traveled, the fare and traffic load along the route (which is largely dependant on the day and time), the weather conditions, etc. It can be inappropriate to ignore these parameters when examining the fuel economy of a vehicle being operated by a particular driver. Other methods of evaluating drivers for driver training are available, such as having a skilled assessor ride in a vehicle being operated by a driver. Should the driver be aware of the presence of an assessor, however, he may alter his driving style temporarily, thus possibly incorrectly rejecting the driver as a good candidate for driver training.

Similarly, it can also be desirable to identify vehicles that are performing poorly. As local maintenance is costly, it can be desirable to prioritize vehicles in terms of their condition and, thus, candidacy for servicing. Any metrics collected over one or more runs along routes during operation of the vehicle can be influenced, however, by the parameters identified above. For the most part, vehicle condition is reported by drivers when a vehicle exhibiting clear signs of requiring service, such as an engine running very roughly, visible smoke from the exhaust, or a significantly under-inflated tire. Otherwise, the condition of the vehicle is generally assessed very infrequently when undergoing a regular scheduled maintenance. As a result, vehicles exhibiting less prominent symptoms may not be quickly identified for servicing.

It is therefore an object of this invention to provide a system and method for analyzing performance data in a transit organization.

### SUMMARY OF THE INVENTION

In accordance with an aspect of the invention, there is provided a method for analyzing performance data in a transit organization using a computer system, comprising:
storing performance data for each of a plurality of runs, said performance data comprising at least one factor, parameters and at least one metric for each of said runs;
selecting for analysis said performance data for a subset of said runs having common parameters and a variation in at least one of said factors; and
comparing said at least one metric for said subset to said at least one metric for other of said runs having said common parameters to determine a relative performance level for said variation.

The parameters can include a route, general time of day, and a vehicle type. The at least one factor can include a driver. The subset of the runs can have a common driver. The selecting and the comparing can be performed iteratively for additional subsets having other common parameters.

The other runs can share the common variation.

The other runs can include all of the runs sharing the common parameters.

The subset can comprise one of the runs. The variation can be a particular vehicle, and the other runs can share the particular vehicle, wherein the relative performance level indicates the degradation in the condition of the vehicle. The parameters can include a vehicle type, wherein the other runs share a particular vehicle type as the particular vehicle, and wherein the relative performance level indicates the condition of the vehicle relative to other the vehicles of the particular vehicle type.

In accordance with another aspect of the invention, there is provided a system for analyzing performance data in a transit organization using a computer system, comprising:
a database server storing performance data for each of a plurality of runs, said performance data comprising at least one factor, parameters and at least one metric for said runs; and
an analysis computer in communication with said database, said analysis computer selecting for analysis said performance data for a subset of said runs having common parameters and a common variation in at least one of said factors, and comparing said at least one metric for said subset to said at least one metric for other of said runs having said common parameters to determine a relative performance level for said variation.

The parameters can include a route, a general time of day, and a vehicle type. The at least one factor can include a driver. The subset of the runs can have a common driver. The analysis computer can select additional subsets of the performance data for the runs sharing the variation and having other common parameters, and compare the at least one metric for the additional subsets to the at least one metric for other of the runs having the other common parameters.

The other runs can share the common variation.

The other runs can include all of the runs sharing the common parameters.

The subset can include one of the runs.

The variation can be a particular vehicle, the other runs can share the particular vehicle, and the relative performance level can indicate the degradation in the condition of the vehicle. The parameters can include a vehicle type, the other runs can share a particular vehicle type as the particular vehicle, and the relative performance level can indicate the condition of the vehicle relative to other the vehicles of the particular vehicle type.

Other and further advantages and features of the invention will be apparent to those skilled in the art from the following detailed description thereof, taken in conjunction with the accompanying drawings.

### BRIEF DESCRIPTION OF THE DRAWINGS

The invention will now be described in more detail, by way of example only, with reference to the accompanying drawings, in which like numbers refer to like elements, wherein:

FIG. 1 is a schematic diagram of a system for analyzing performance data in a transit organization in accordance with an embodiment of the invention, and its operating environment;

FIG. 2 is a block diagram of an on board unit installed in the vehicle shown in FIG. 1;

FIG. 3 is an exemplary set of performance data records stored in the performance data database of FIG. 1;

FIG. 4 is a flowchart of the general method of analyzing performance data carried out by the system of FIGS. 1; and

FIG. 5 is a schematic diagram of the system for analyzing performance data in accordance with another embodiment of the invention, and its operating environment.

### DETAILED DESCRIPTION OF THE EMBODIMENTS

It can be desirable for transit organizations to collect performance data for its vehicle fleet, and then analyze the performance data to more clearly understand it. If transit organizations could more readily recognize trends in the performance data and attribute the trends to specific factors, they could identify drivers that are good candidates for driver training and vehicles that would benefit most from servicing, as well as provide recognition to drivers performing well.

Performance is measured by metrics. There are a variety of metrics that can be of interest to transit organizations. One important metric is fuel economy. It is generally desirable to reduce the overall fuel expenditure of a transit organization. Another set of metrics relate to the “jerkiness” of a ride. Other metrics relate to, for example, the measured position of the acceleration pedal and the brake pedal. Intelligent comparison of these metrics permits analysis and evaluation of drivers and/or vehicles.

### Factors

There are a number of factors that can affect the performance of transit vehicles and the services provided by a transit organization. Factors can be thought of as inputs that have a direct impact on the performance and quality of service over one or more routes. The two factors that will be discussed are the driver and the vehicle.

The driving skills and habits of a driver can have a significant impact on the fuel economy of a vehicle. Similarly, good driving skills and habits also generally equate to a satisfactory experience for commuters riding on a vehicle. A number of principles that characterize good driving skills and habits are listed below.

Slow, smooth acceleration from a stop: Slow, smooth acceleration from a stop position consumes considerably less fuel than quick, heavy-footed acceleration. A vehicle's engine is kept operating at a more efficient revolutions-per-minute (“RPM”) range during slow acceleration than when accelerating quickly, thereby also reducing the stress and wear placed on the engine. Additionally, smooth, gentle acceleration from a stop provides, not surprisingly, a less jerky riding experience for commuters.

Slow, smooth breaking: Slow, smooth breaking when approaching an expected stop causes significantly less wear on the break components of a vehicle in comparison to abrupt application of the brakes. Additionally, slow, smooth breaking provides a less jerky riding experience for commuters.

Modest idling: When a vehicle is expected to remain stationary for a number of minutes, the savings on fuel consumption achieved by turning off the engine exceeds the cost of additional wear on the engine by restarting it.

Moderate speed: A vehicle is less stressed and consumes less fuel when driven at moderate speeds in comparison to higher speeds. By maintaining the RPMs of the engine in a lower, more-efficient range, fuel can be saved. Additionally, irregularities in the road surface challenge the suspension of vehicles when they are driven at lower speeds, thus providing a smoother ride for commuters. Further, moderate speeds are associated with lower incident rates and with reduced severity of incidents, and are thus associated with lower liabilities.

Minimal anticipation: Anticipation refers to the practice of releasing the brake pedal in anticipation of a green light. As is often the case, a green light may occur more slowly than expected, resulting in a need to reapply the brake. The result is unnecessary jerking of commuters and additional wear on the brake components.

Similarly, the condition of a vehicle can vary significantly, thus impacting the fuel economy and other metrics of the vehicle. There are many ways in which the condition of a vehicle can be poor. For example, a filter can be underperforming, either due to being dirty or otherwise malfunctioning. One or more spark plugs may not be firing correctly. The fuel injection system or carburetor may be providing a sub-optimal mix of fuel and air. The tire pressure may not be optimal. Any of these can result in poor fuel economy.

By analyzing the relationships between the factors and the performance data, variations of the factors that correspond to good or poor performance can be identified. For example, when a first driver operates a particular vehicle, he may operate its in a more fuel-efficient manner than a second driver, suggesting that the first driver has driving skills and habits that lead to better fuel efficiency than those of the second driver. Similarly, when a driver operates a first vehicle, the fuel economy can be better than when operates a second vehicle. All other things being equal, this suggests that the first vehicle is in better condition than the second vehicle, at least from a fuel economy point-of-view.

In order to be able to properly compare performance data collected by a transit organization, it can be desirable to compare variations in factors between runs that were completed under similar circumstances.

### Parameters

Parameters are used to characterize runs and include, but are not limited to, the vehicle type, the route traveled, and the general time of day during a vehicle is operated. Other parameters affecting a vehicle's metrics exist, such as irregular events that trigger fluctuations in the volume of fares or the traffic present, driving conditions precipitated by bad weather or passenger medical emergencies. In the described embodiment, these other parameters are ignored.

The vehicle type can significantly affect the performance of a vehicle. A transit organization can employ a number of different types of vehicles, each employing a different engine, having a different weight, geared differently, etc. As a result, these different vehicle types can have varying expected fuel economies and other metrics.

Each route can have a significant impact on the performance of a vehicle. Some routes can have a high density of passenger and/or traffic stops, thus requiring the vehicle to start and stop more frequently per kilometer. Some routes can be hillier than other routes, causing more fuel to be consumed per kilometer than over flatter routes.

The day-time block generally identifies the general time of day during which a vehicle is operated. Each day is categorized as either a weekday or a weekend day. Further, a number of day-time blocks are defined for weekdays and for weekend days based on volume of traffic, fares, etc. In particular, weekdays are divided into a first day-time block from midnight to 6:30 AM, a second day-time block from 6:30 AM to 9:30 AM denoting the morning rush hour, a third day-time block from 9:30 AM to 3:00 PM, a fourth day-time block from 3:00 PM to 7:00 PM denoting the afternoon rush hour, and a fifth day-time block from 7:00 PM to midnight. Weekend days are divided into day-time blocks in a similar manner. During day-time blocks that encompass rush hours, vehicular traffic over most routes is generally heavier than at other times, and the number of fares is larger. Both the greater volumes of vehicles and commuters translate into more stops for a vehicle.

The invention provides a system and method for analyzing performance data in a transit organization. By comparing metrics for a subset of runs having common parameters and a common variation in at least one of the factors to metrics for other runs having the same parameters, a relative performance level for the variation can be determined. That is, by comparing the performance of a driver or vehicle to that of other drivers or vehicles over runs that have similar characteristics, more significance can be given to the results.

### System and Operating Environment

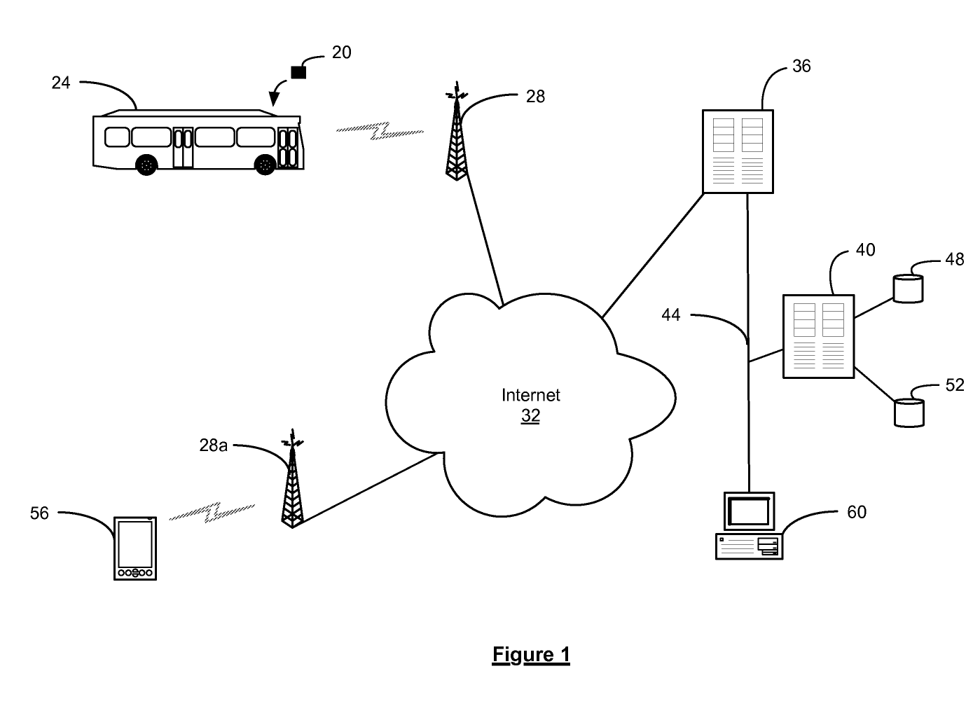

FIG. 1 shows a system for analyzing performance data in a transit organization in accordance with an embodiment of the invention, and its operating environment.

An on board unit (“OBU”) 20, commonly referred to as a “black box”, is installed in a transit vehicle 24. The OBU 20 is a device that collects performance data about the vehicle while the vehicle is in operation, temporarily stores the performance data, and then transmits the performance data at regularly scheduled intervals. The OBU 20 is secured inside the vehicle 24 so that it is not easily removable without the use of a screwdriver. The OBU 20 is shown in communication with a cellular base station 28 for transmission of the performance data. The cellular base station 28 is coupled to the Internet 32 via a number of intermediate proxies and servers that form part of the infrastructure of a cellular communications carrier (not shown).

A gateway 36 is also coupled to the Internet for receiving performance data from the OBU 20. The functionality of the gateway 36 is provided by an application service operating on a server of the transit organization. Upon receiving the performance data, the gateway 36 transfers the performance data to a database server 40 coupled to the gateway 36 over a local area network 44. The database server 40 stores the performance data in a performance data database 48. In addition, the database server 40 manages a scheduling database 52 that stores scheduling information for vehicles and drivers in the transit organization. Some of the scheduling data is merged by the database server 40 with the performance data stored in the performance data database 48. Namely, driver-vehicle associations specifying which driver was operating which vehicle are transferred to the performance data database 48 for merging with the other performance data.

A mobile device 56 is also in communication with a cellular base station 28a that is similar to cellular base station 28 in many respects except that it may form part of the infrastructure of a separate cellular communications carrier. The cellular base station 28a is also in communication with the Internet 32 via a number of intermediate proxies and servers that form part of the infrastructure of the cellular communications carrier (not shown). The mobile device 56 permits a schedule manager to input and modify schedule changes, including driver changes, vehicle changes, and changes to runs along routes (such as “short-turning” a vehicle).

An analysis computer 60 is coupled to the database server 40 over the local area network 44 for analyzing the performance data stored in the performance data database 40. The analysis computer 60 executes a monitoring application that has an “adapter” that receives data from the gateway 36. The “adapter” is a communication service that connects a browser-based monitoring tool to the gateway 36 and refreshes the latest performance data as the gateway 36 receives updates from the OBUs 20.

The monitoring application also has analysis tools that support generic reports and dashboards. For example, fuel monitoring tools include fuel consumption, fuel efficiency and idle time reports with drill-downs by date, vehicle, driver and pattern.

Real-time and historical dashboards with a variety of visualizations (graphs, pie charts and gauges) are available to give managers a summary of the vehicle fleet's performance at a glance. Managers will also be able to set thresholds on specific performance metrics so that they may identify areas for potential improvement.

A real-time aspect of the monitoring application can be effectively used by management to oversee the operation and provide valuable feedback. For example:
real-time vehicle tracking that pinpoints each vehicle's location on a map
real-time information displayed as tool tips for each vehicle on the map—speed, driver, route, vehicle, direction, fuel usage, idle time, etc.
route/driver/vehicle assignment data displayed for the selected vehicle
support for a Google map with a terradata overlay
ability to define a subset of engine metrics to be displayed
security to control access to data by user, garage, division, provider, etc.
schedule adherence

Additionally, the monitoring application has a component that can be used to determine driver and vehicle trends over time via analysis of the performance data in the performance data database 48. Using this information, the monitoring application can directly alert the fleet maintenance department that a particular vehicle is underperforming. Similarly, the monitoring application can directly alert human resources that a driver is exceeding performance expectations or underperforming.

Data Collection from the Vehicle

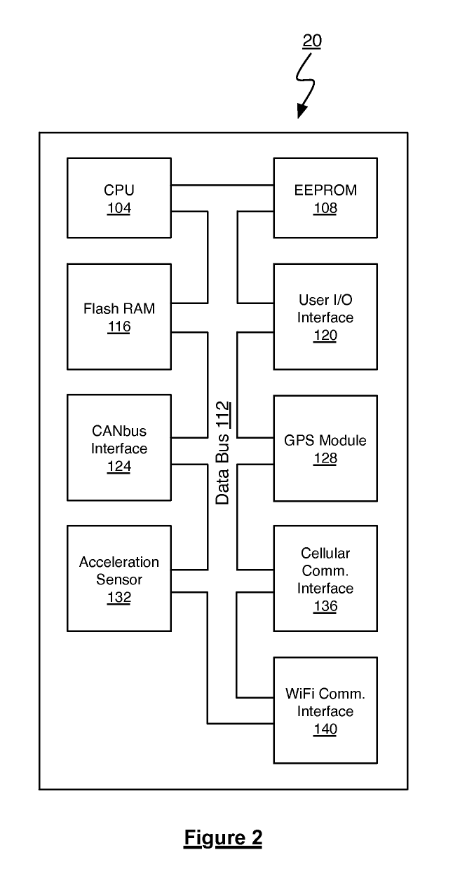

FIG. 2 is a schematic diagram showing a number of components of the OBU 20. The OBU 20 includes a central processing unit 104 that manages the operation the OBU 20 via an operating system stored in an EEPROM 108 and accessed over a local data bus 112. A bank of flash RAM 116 stores settings and data collected during operation of the vehicle 20. In particular, 16 megabytes have been found to be sufficient for the application. A user input/output interface 120 permits configuration of the OBU 20. The user input/output interface 120 includes a USB port to enable the OBU 20 to be reprogrammed or reconfigured, and a reset button to reboot the OBU 20 when it is found to be functioning erratically.

A controller area network bus (“CANbus”) interface 124 receives metrics from the engine and, similarly to a standard serial interface, uses a nine-pin connector. The CANbus interface reports 124 separate vehicle metrics, including, but not limited to, the engine temperature, the oil pressure, distance traveled (odometer deltas), speed, fuel usage, brake pedal position, throttle pedal position, and idle time. The particular metrics that are recorded by the OBU 20 are vehicle speed, fuel usage, breaking, throttle and idling.

A global positioning system (“GPS”) module 128 registers the position of the OBU 20 and, hence, the vehicle 24 in which the OBU 20 is installed. The OBU 20 can then append location information onto data collected to register its context. Additionally, the OBU 20 can transmit the location information to the gateway 36 to enable live tracking of the vehicle 24.

An acceleration sensor 132 registers and reports acceleration metrics, which are measured along three axes. The acceleration metrics supplement the other metrics collected via the engine interface 124, and more readily indicates rapid changes in the movement of the vehicle 24 generally associated with less desirable driving skills and habits and a lower quality of ride for commuters.

A cellular communications interface 136 communicates data collected by the OBU 20 to the gateway 36 via the cellular base station 28. The cellular communications interface 136 uses any one of GPRS, 1XRTT, EDGE, HSDPA, Mobitex, or another Internet Protocol-based data radio standard, to communicate with the cellular base station 28.

A WiFi communications interface 140 is also present in the OBU 20 for situations where less-frequent WiFi data uploads via short-ranged wireless communications are opted for in place of more frequent cellular communications.

Each OBU 20 has a unique identifier that is transmitted during communications either via the cellular communications interface 136 or via the WiFi communications interface 140. The unique identifier of the OBU 20 is associated with a vehicle 24 into which the OBU 20 has been installed, and this association is registered in a performance data database 48.

While the CANbus interface 124 reports these metrics each second, it may not be desirable to report all these metrics to the gateway 36 or to store all of these metrics in the flash RAM 116. Accordingly, the OBU 20 processes and aggregates some of these metrics for user-defined n-second time intervals. For example, the distance traveled, fuel usage and idling time can be aggregated over twenty-second time intervals, whereas speed, throttle pedal position and brake pedal position are averaged over the same intervals. The OBU 20 then records the performance data for this time interval in the flash RAM 116 and sends it to the gateway 36, along with the day/time and location information, at the end of each time interval. The frequency can be adjusted to accommodate for, amongst other factors, the cost of data communications over the cellular communications network.

### Driver-Vehicle Association

The performance data collected via the OBU 20 and stored in the performance data database 48 is combined with scheduling data from the scheduling database 52 that indicates which driver was driving which vehicle at what day and time. When merged, this scheduling data becomes part of the performance data. In the absence of an existing driver identification system in vehicles, the system relies on driver-vehicle pairings from the scheduling database 52 from ‘pull out’ to ‘pull in’ of a driver with a vehicle 24.

The association of a driver with a vehicle stored in the scheduling database 52 comes from two sources of information—the planned service and the actual service. The planned service is the result of a formal scheduling process that considers the following when assigning drivers to vehicles:
the trips that need to be performed
the way these trips are linked together into vehicle assignments called blocks and defined by a pull-out time/location to a pull-in time/location
the division of the vehicle assignments into pieces of work assignments for drivers called “runs” and defined by an ‘on bus’ time/location to an ‘off bus’ time/location
the allocation of the work assignments to drivers, taking into account any planned absences, such as vacations
   The planned service is planned using a bidding process that is a commonplace approach for problems where demand and supply are to be matched.

When a driver starts his work assignment, he is allocated a vehicle. The driver will stay with that vehicle until he is either relieved by another driver or the vehicle is returned back to the depot at the end of the block. This means that, based upon the work assignments, the driver can operate more than one vehicle and a vehicle can be operated by more than one driver over a block.

What actually happens on the day of service, however, may be very different from the planned service. Drivers may call in sick or not turn up and will need to be substituted, vehicles may break down and need to be replaced, and so on. In order to ensure that an accurate picture of the day is recorded, all the exceptions to the planned service must be noted. It is therefore a combination of the planned service and the recorded exceptions to that planned service that defines the true daily events for the drivers and the vehicles. Recording driver-vehicle assignments accurately is important if an accurate driver or vehicle performance analysis is to be performed.

### Merging and Analysis of the Performance Data

During regular operation, the database server 40 merges the performance data from the performance data database 48 with the adjusted planned service data from the scheduling database 52 for the runs along the plurality of routes. In particular, during the merging, records for runs in the performance data are matched up with the adjusted planned service by determining when a vehicle was being operated by a particular driver, based on the pull-out and pull-in data, and associating runs for that vehicle over that period of time with that driver. Some checks are subsequently performed to evaluate the integrity of the data to ensure that the merged data is valid (e.g., that a driver was not registered as driving two vehicles simultaneously or that a vehicle was not performing two runs simultaneously).

The performance data is filtered to remove runs having any changes in the vehicle or driver performing the run along the route. When a run includes a change in the vehicle or driver, the performance data cannot be attributed to a single driver and vehicle combination, which is the goal. During the regular course of daily operation, variables for each run are registered. These variables include the particular vehicle, the particular driver, the route driven, the driving conditions, the time of day the runs are performed, etc. In many cases, runs can be cut short or the variables can be changed mid-run for a variety of reasons:

Vehicle short-turn: It can be decided to short-turn a vehicle for a number of reasons. For example, it can be advantageous to redirect a vehicle in the opposite direction along the same route where the perceived fare volume commuting in that direction is not being served well enough.

Driver change: Drivers can be changed mid-run along a route for a number of reasons. This can be done to provide drivers with the appropriate rest periods and/or meal breaks. A driver may feel ill and may need to be relieved.

Vehicle change: Vehicles can also be changed mid-run along a route. Typically, this is done where a vehicle is perceived to be underperforming.

The present system discards data for runs that were cut short or where the variables were changed mid-run so that data from complete runs can be compared to other data from complete runs.

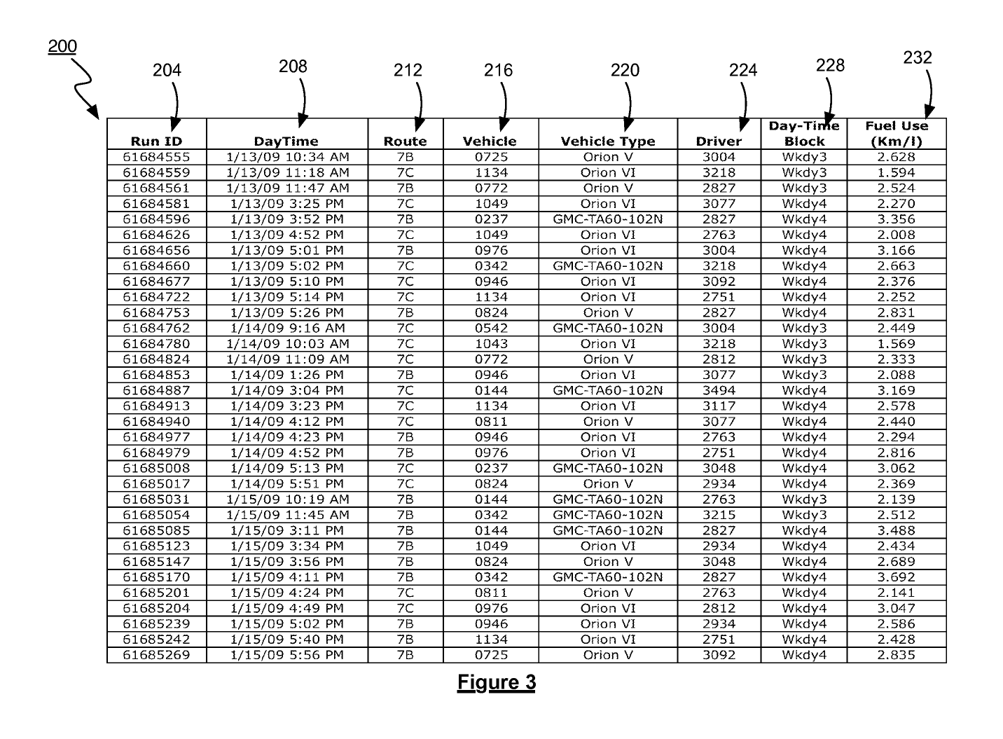

FIG. 3 shows an exemplary dataset 200 for a sample set of runs. The shown dataset 200 only shows one metric for ease of illustration. The merged dataset 200 includes a run ID field 204, a day/time field 208, a route field 212, a vehicle field 216, a driver field 220, a day-time block field 224, and a fuel economy field 232. Each run along a route is assigned a unique ID, namely the run ID 204. The day/time field 208 registers the date and time at the start of a run. The route field 212 identifies the route along which the run is performed. The vehicle field 216 identifies the unique ID assigned to the vehicle that performed the run. The driver field 220 identifies the unique ID assigned to the driver that operated the vehicle for the run. The day-time block field 224 is determined using the date/time field 208 and pre-defined parameters for each route, namely the estimated time of completion of the route. Using the start time (that is, the day/time field 208) and the estimated time to completion of the route identified by the route field 212, each run is slotted into one of the pre-defined day-time blocks and this day-time block is recorded in the day-time block field 224.

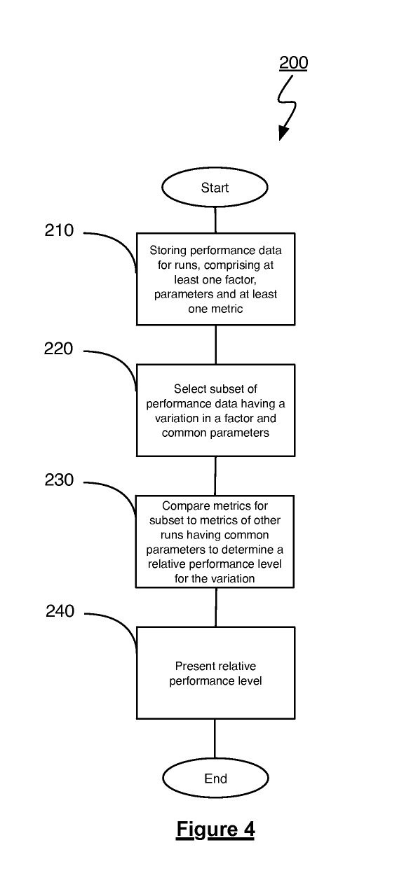

FIG. 4 is a flowchart showing the general method of analyzing the performance data employed by the analysis computer 60 generally at 300. By grouping runs that occur over a particular route during a particular day-time block with a particular type of vehicle together, variations in these parameters can be “eliminated”. In this manner, better comparisons can be made between drivers, or between a driver and his past performance. Similarly, better comparisons can be made between vehicles, or between a vehicle and its past performance.

The method begins with the storing of performance data for runs (step 210). The performance data database 48 includes, for each of the runs, at least one factor, parameters and at least one metric.

A subset of the performance data having common parameters and a common variation in a factor is selected (step 220). Depending on the type of comparison, the subset can include performance data for a single run or for multiple runs having the common variation.

The performance data for the subset is then compared to other performance data having common parameters to determine a relative performance level for the variation (step 230). The other performance data is selected based on the type of comparison.

The relative performance level is then presented (step 240). Once the relative performance level is determined, it is then presented by the monitoring application executing on the analysis computer 60.

In order to illustrate the method in practice, a number of examples will be described.

### EXAMPLE 1

### Comparing Performance of Vehicle Over a Run to Previous Performances of the Vehicle

It can be of interest to analyze the performance of a vehicle over a recent run over a route. In this case, the metric “fuel economy” will be used as a measure of performance. One method entails comparing the metrics for that run to previous runs performed by the same vehicle over the same route over the same day-time block. In this case, the subset of performance data selected at step 220 is the performance data for the particular run of interest for the particular vehicle. As the vehicle's performance over the current run is to be compared to all previous performances of the particular vehicle over the same route and day-time block, the fuel economy metric for the particular run is compared to the average fuel economy metric for all other records for the same vehicle over the same route during the same day-time block to determine a relative performance level at step 230.

Referring back to FIG. 4, if the performance of the ‘0946’ vehicle over the run with a run ID of 61685239 is of interest, the record for that particular run is selected as a subset of the performance data at step 220. The fuel economy metric for that subset is then compared to the fuel economy for the other runs performed by that vehicle over the same route during the same day-time block. In the dataset 200 shown in FIG. 3, there is only one other run performed by the ‘0946’ vehicle over the same route during the same day-time block: the run with run ID ‘61684977’. The average of the ‘fuel economy’ metric for the other run(s) is simply the ‘fuel economy’ metric for the particular run; namely, 2.294 km/l. That metric is compared to the metric for the subset selected at step 220; namely, 2.586 km/l. The relative performance level is therefore 2.586 divided by 2.294, or 1.123. This relative performance level indicates that the performance of the vehicle over the recent run exceeds the performance of the vehicle over previous runs along the same route during the same day-time block.

### EXAMPLE 2

### Comparing Performance of Driver Over a Run to the Best Performance of All Drivers Over the Same Route Using the Same Vehicle Type During the Same Day-Time Block

The performance of a particular driver over a particular run in relation to the best performance for all other drivers can be of interest. Again, the metric “fuel economy” will be used as a measure of performance. In this case, the subset of performance data selected at step 220 is the performance data for the particular run of interest for the particular driver. Say, for example, the performance of driver ‘2934’ is of interest over the run with run ID 61685239. This run has a ‘fuel economy’ metric of 2.586 km/l. As the driver's performance over the current run is to be compared to the best performance by all other drivers using the same vehicle type on the same route during the same day-time block, the fuel economy metric for the particular run is compared to the best fuel economy metric for all other records for the same vehicle type over the same route during the same day-time block to determine a relative performance level at step 230. The records that match these criteria are the ones with run IDs ‘61684979’, ‘61685123’ and ‘61685242’. The best ‘fuel economy’ metric for these runs is 2.816 km/l for run ID ‘61684979’. Comparing the metric for the subset to the other runs, a relative performance level of 0.910 (equal to 2.586 divided by 2.816) is determined.

### EXAMPLE 3

### Comparing Performance of Driver Over a Run to the Average Performance of All Drivers Over the Same Route Using the Same Vehicle Type During the Same Day-Time Block

The performance of a particular driver over a particular run in relation to the average performance for all other drivers can be of interest. Again, the metric “fuel economy” will be used as a measure of performance. In this case, the subset of performance data selected at step 220 is the performance data for the particular run of interest for the particular driver. Say, for example, the performance of driver ‘2934’ is of interest over the run with run ID 61685239. This run has a ‘fuel economy’ metric of 2.586 km/l. As the driver's performance over the current run is to be compared to the average performance by all other drivers using the same vehicle type on the same route during the same day-time block, the fuel economy metric for the particular run is compared to the average fuel economy metric for all other records for the same vehicle type over the same route during the same day-time block to determine a relative performance level at step 230. The records that match these criteria are the ones with run IDs ‘61684979’, ‘61685123’ and ‘61685242’. The average ‘fuel economy’ metric for these runs is 2.559 km/l. Comparing the metric for the subset to the other runs, a relative performance level of 1.011 (equal to 2.586 divided by 2.559) is determined. This relative performance level indicates that the particular driver performed slightly better than the average for the other drivers using the same vehicle type over the same route during the same day-time block.

### EXAMPLE 4

### Comparing Performance of Driver Over All Runs to the Average Performance of All Drivers Over the Same Route Using the Same Vehicle Type During the Same Day-Time Block

This analysis is similar to that of Example 3, except that the average performance of a particular driver versus all other drivers is of interest here. Again, the metric “fuel economy” will be used as a measure of performance. In this case, the subset of performance data selected at step 220 is the performance data for all runs for the particular driver over the particular route, using the particular vehicle type during the particular day-time block. Say, for example, the performance of driver ‘2934’ over the ‘7B’ route using an ‘Orion VI’ vehicle type during the ‘Wkdy4’ day-time block is of interest. There are two such runs performed by this driver, run IDs ‘61685239’ and ‘61685123’. The average ‘fuel economy’ metric for these runs is 2.510 km/l. As the driver's performance over the current run is to be compared to the average performance by all other drivers using the same vehicle type on the same route during the same day-time block, the fuel economy metric for the particular run is compared to the average fuel economy metric for all other records for the same vehicle type over the same route during the same day-time block to determine a relative performance level at step 230. The records that match these criteria are the ones with run IDs ‘61684979’, ‘61685123’ and ‘61685242’. The average ‘fuel economy’ metric for these runs is 2.559 km/l. Comparing the metric for the subset to the other runs, a relative performance level of 0.981 (equal to 2.510 divided by 2.559) is determined. This relative performance level indicates that the particular driver performed slightly better on average than other drivers using the same vehicle type over the same route during the same day-time block.

### EXAMPLE 5

### Comparing Performance of Driver to the Average Performance of All Drivers Over All Runs

It can be desirable to compare the performance of a particular driver to that for all drivers over all runs. This can be useful for identifying drivers that make good candidates for driver training. As before, the metric “fuel economy” will be used as a measure of performance. In this case, the same analysis as described in Example 4 above is employed for every combination of route, vehicle type and day-time block. Once the relative performance levels have been determined for each combination of route, vehicle type and day-time block, a weighted average is determined based on the number of runs the particular driver performed for each combination of route, vehicle type and day-time block. The weighted average provides the overall relative performance level for the particular driver.

As will be understood, the same kind of analysis can be performed for a particular vehicle, and/or over a portion of all combinations of route, vehicle type and day-time block.

### Alternative Data Communication Configuration

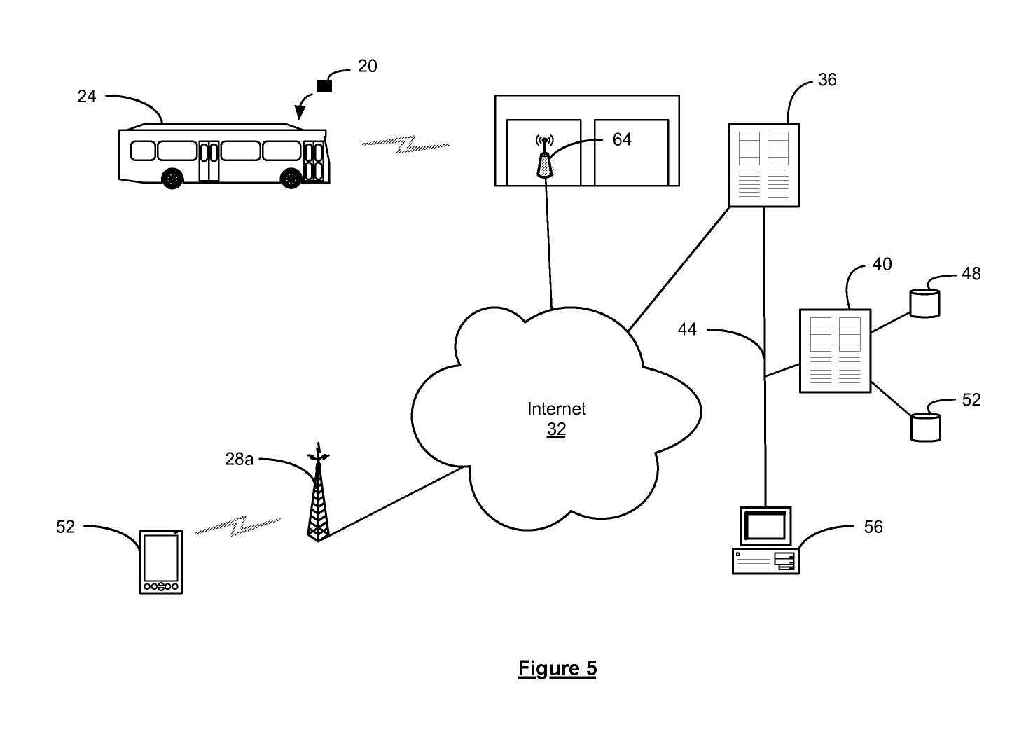

FIG. 5 shows a second embodiment with an alternate configuration wherein the cellular communications interface 136 of the OBU 20 is disabled. In this configuration, the metrics collected by the OBU 20 are stored and then communicated when the vehicle 24 is at a vehicle depot. The vehicle depot has one or more digital enhanced cordless telecommunications (“DECT”) units 64 that are coupled to the Internet via a router (not shown). When the vehicle 24 is proximate to the DECT unit 64, the OBU 20 initializes communications with the DECT unit 64 and communicates the metrics collected during the runs since the last data uploading (typically once a day). This process typically takes less than ten seconds.

While the day-time blocks are described as being uniform across all routes, it may be desirable in some circumstances to define the blocks differently for each route. For example, some routes may have different busy periods, such as, for example, routes that travel to or past shopping malls. Other routes may not generally be affected by rush hours. In such cases, it can be desirable to model the day-time blocks for subsets of the routes to accommodate such variations in the volumes of passengers or traffic experienced by the subsets of routes.

This concludes the description of the presently preferred embodiments of the invention. The foregoing description has been presented for the purpose of illustration and is not intended to be exhaustive or to limit the invention to the precise form disclosed. It is intended the scope of the invention be limited not by this description but by the claims that follow.

What is claimed is:

1. A method for analyzing performance data in a transit organization using a computer system, comprising:
storing performance data for each of a plurality of runs, said performance data comprising at least one factor, parameters and at least one metric for each of said runs;
selecting for analysis said performance data for a subset of said runs having common parameters and a common variation in at least one of said factors; and
comparing said at least one metric for said subset to said at least one metric for other of said runs having said common parameters to determine a relative performance level for said variation.

2. The method of claim 1, wherein said parameters include a route and a general time of day.

3. The method of claim 2, wherein said parameters additionally include a vehicle type.

4. The method of claim 1, wherein said at least one factor includes a driver.

5. The method of claim 4, wherein said subset of said runs has a common driver.

6. The method of claim 4, wherein said selecting and said comparing are performed iteratively for additional subsets having other common parameters.

7. The method of claim 1, wherein said other of said runs share said common variation.

8. The method of claim 1, wherein said other of said runs include all of said runs sharing said common parameters.

9. The method of claim 1, wherein said subset comprises one of said runs.

10. The method of claim 9, wherein said variation is a particular vehicle.

11. The method of claim 10, wherein said other runs share said particular vehicle, and wherein said relative performance level indicates the degregation in the condition of said vehicle.

12. The method of claim 10, wherein said parameters include a vehicle type, wherein said other runs share a particular vehicle type as said particular vehicle, and wherein said relative performance level indicates the condition of said vehicle relative to other said vehicles of said particular vehicle type.

13. A system for analyzing performance data in a transit organization using a computer system, comprising:
a database server storing performance data for each of a plurality of runs, said performance data comprising at least one factor, parameters and at least one metric for each of said runs; and
an analysis computer in communication with said database, said analysis computer selecting for analysis said performance data for a subset of said runs sharing common parameters and a common variation in at least one of said factors, and comparing said at least one metric for said subset to said at least one metric for other of said runs having said common parameters to determine a relative performance level for said variation.

14. The system of claim 13, wherein said parameters include a route identification and a general time of day.

15. The system of claim 14, wherein said parameters additionally include a vehicle type.

16. The system of claim 13, wherein said at least one factor includes a driver.

17. The system of claim 16, wherein said subset of said runs has a common driver.

18. The system of claim 16, wherein said analysis computer selects additional subsets of said performance data for said runs sharing said common variation and having other common parameters, and compares said at least one metric for said additional subsets to said at least one metric for other of said runs having said other common parameters.

19. The system of claim 13, wherein said other of said runs share said common variation.

20. The system of claim 13, wherein said other of said runs include all of said runs sharing said common parameters.

21. The system of claim 13, wherein said subset comprises one of said runs.

22. The system of claim 21, wherein said variation is a particular vehicle.

23. The system of claim 22, wherein said other runs share said particular vehicle, and wherein said relative performance level indicates the degregation in the condition of said vehicle.

24. The system of claim 22, wherein said parameters include a vehicle type, wherein said other runs share a particular vehicle type as said particular vehicle, and wherein said relative performance level indicates the condition of said vehicle relative to other said vehicles of said particular vehicle type.
